(19) United States
(12) Patent Application Publication
(10) Pub. No.: US 2018/0290763 A1
(43) Pub. Date: Oct. 11, 2018

(54) SKY TREE AND SKY FOREST FOR UNMANNED AERIAL VEHICLES

(71) Applicant: JCD Optical (Cayman) Co., Ltd., Grand Cayman (KY)

(72) Inventor: Shihwa Huang, New Taipei City (TW)

(21) Appl. No.: 16/003,128

(22) Filed: Jun. 8, 2018

Related U.S. Application Data
(63) Continuation of application No. PCT/CN2016/109477, filed on Dec. 12, 2016.

(30) Foreign Application Priority Data
Dec. 10, 2015 (CN) 201510908875.6

(51) Int. Cl. B64F 1/22; B64F 1/28; B64F 1/36; B64C 39/02; G08G 5/00; G05D 1/10; G05D 1/00

(52) U.S. Cl. CPC B64F 1/222; B64F 1/28; B64F 1/362; B64C 39/024; G08G 5/0043; G08G 5/0013; H04W 84/042; G05D 1/104; G05D 1/0022; G05D 1/0027; B64C 2201/20; B64C 2201/146; G08G 5/003

(57) ABSTRACT

A sky tree for unmanned aerial vehicles includes a trunk, a flight platform, an elevator, a parking room, a command center, and a supply station. The sky tree is arranged in a geographic region to provide the unmanned aerial vehicles in the region for certain application field with logistics support integrating command dispatching, application monitoring, communication relay, and replenishment. A sky forest for unmanned aerial vehicles includes a plurality of sky trees for unmanned aerial vehicles arranged in a geographic region, and a control center. The sky forest becomes part of the public property in the geographic region, provides logistics support for all unmanned aerial vehicles in the region, and controls flights of the unmanned aerial vehicles in an orderly manner.

### CROSS REFERENCE TO RELATED APPLICATIONS

The present application is a Continuation Application of PCT Application No. PCT/CN2016/109477 filed on Dec. 12, 2016, which claims the benefit of Chinese Patent Application No. 201510908875.6 filed on Dec. 10, 2015. All the above are hereby incorporated by reference.

### TECHNICAL FIELD

The present disclosure relates to the technical field of unmanned aerial vehicles, and in particular to a sky tree and a sky forest for unmanned aerial vehicles.

### BACKGROUND

Unmanned aerial vehicle, abbreviated as “UAV”, is an unmanned aircraft which is manipulated by radio remote control equipment and self-provided with a program-controlled device. Unmanned aerial vehicles plus industry applications are the real need of unmanned aerial vehicles. At present, the use of unmanned aerial vehicles in the field of aerial photography, agricultural plant protection, surveying and mapping, and other fields of application greatly expands the use of unmanned aerial vehicles themselves.

With the development and penetration of the application of unmanned aerial vehicles, the technology of unmanned aerial vehicles has developed rapidly. However, the research of logistic support system for these unmanned aerial vehicles is relatively few.

Chinese Patent Application Publication No. CN103176475A discloses a ground station for unmanned aerial vehicles which is simple in operation and includes a wireless transmission module and a computer control platform. A controller sends a response command signal to control the unmanned aerial vehicles through the computer control platform and the wireless transmission module. The unmanned aerial vehicles transmit the status information to the computer control platform in real time through the wireless transmission module. The computer control platform displays in real time the unmanned aerial vehicle flight status parameters and their position status in a navigation map. This achieves the simple operation of the unmanned aerial vehicles and simplifies the difficulty in unmanned aerial vehicle manipulation through two control modes, namely simple keyboard control and direct parameter control.

Chinese Patent Application Publication No. CN105068545A discloses an intelligent carrier platform for unmanned aerial vehicles for the improvement of saline-alkali land. It includes a platform mounted on the ground inside a building and can extend perpendicular to the horizontal direction of the building. The platform includes an unmanned aerial vehicle entrance end and an unmanned aerial vehicle exit end. The unmanned aerial vehicle exit end is provided with a downwardly depressed trough. The trough is equipped with an elastic board. The elastic board is fixedly connected to the platform at the side of the unmanned aerial vehicle exit end. The elastic board is provided with a lift bar near the bottom side of the unmanned aerial vehicle exit end. The carrier platform is used for unmanned aerial vehicles which can carry out aerial inspection and can transmit data to data terminal in real time. Radar and antenna can be used to navigate the unmanned aerial vehicles.

The above patented technologies pay more attention to the improvement of the individual technical issues of unmanned aerial vehicle manual control, and unmanned aerial vehicle take-off and landing. They do not pay attention to the logistic support of take-off and landing, communication command, replenishment, flight monitoring of the unmanned aerial vehicles as a whole.

Chinese Patent Application Publication No. CN104494503A discloses an integrated rectangular cabin system for unmanned aerial vehicles. The system includes a truck, a sectional rectangular cabin, unmanned helicopters, ground command and control station, automatic launch/recovery and lift control system, maintenance and support system, and power system. The ground command and control station is located at the front portion of the sectional rectangular cabin for flight control and task deployment of the unmanned helicopters. The automatic launch/recovery and lift control system is the launching platform for the unmanned helicopters. The maintenance and support system includes an automatic mixed refueling system, and a storage and transportation locking system for the equipment replacement and repair maintenance of the unmanned helicopters and locking the unmanned helicopters in the rectangular cabin.

Chinese Patent Application Publication No. CN105035340A discloses a multi-functional flight platform for unmanned aerial vehicles, which includes an unmanned aerial vehicle dispatch and command system for dispatching and commanding the unmanned aerial vehicles, an unmanned aerial vehicle application monitoring system for monitoring the flight status of the unmanned aerial vehicles, a communication and communication relay system for wireless communication with the unmanned aerial vehicles, and a power source maintenance system for supplying power source to the unmanned aerial vehicles. It keeps the unmanned aerial vehicle power, communication relay, remote command, flight monitoring, equipment storage, maintenance, take-off and landing functions together on a movable platform. This provides effective monitoring and logistic support for the unmanned aerial vehicles, prolongs the flight time of the unmanned aerial vehicles, and improves the efficiency of the unmanned aerial vehicles.

The above patented technologies pay an overall attention to the aspects of logistic support of unmanned aerial vehicles such as dispatching command, application monitoring, communication relay. However, a normal car is used as a basic platform for refitting and application. It integrates with the car and supports the relevant application of unmanned aerial vehicles. It is still directed to some specific unmanned aerial vehicles, and its multi-functional flight platform is still an ancillary product of the unmanned aerial vehicles. It cannot widely match with other types of unmanned aerial vehicles and cannot turn the multi-functional flight platform into public property.

### SUMMARY

In view of the shortcomings of existing technologies, one of the objects of the present disclosure is to provide a sky tree for unmanned aerial vehicles, which is arranged in a geographical region, such as a city or a border, to provide logistic support for the unmanned aerial vehicles in the region in a certain field of application, which integrates dispatching command, application monitoring, communication relay and replenishment.

Another object of the present disclosure is to provide a sky forest for unmanned aerial vehicles, which is arranged in a geographical region, such as a city or a border, so that it becomes the public property in that region and can provide logistic support for all unmanned aerial vehicles in the region and carry out orderly flight control.

To achieve the above objects, the present disclosure provides a sky tree for unmanned aerial vehicles, including:

a trunk extending from a lower portion to a high altitude, an inner portion of the trunk having a hollow structure;

a flight platform located at a top end of the trunk for take-off and landing of the unmanned aerial vehicles;

an elevator provided inside the trunk for carrying the unmanned aerial vehicles up or down between the lower portion and the flight platform;

parking rooms for parking of the unmanned aerial vehicles; and

a command center to control flights of the unmanned aerial vehicles using radio communication.

Preferably, the sky tree for unmanned aerial vehicles further includes a supply station to recharge or refuel the unmanned aerial vehicles.

Preferably, the command center uses 2G, 3G or 4G mobile communication, GPS communication, or specific channel radio communication.

Preferably, the sky tree for unmanned aerial vehicles is in the overall shape of a tower, and the parking rooms are provided on the trunk to form a multi-layer branching structure.

The tower-shaped sky tree itself, formed by the trunk and branches, is a large radio antenna. It can be used as a communication relay system for the unmanned aerial vehicles to facilitate communication of the unmanned aerial vehicles. In addition, the parking rooms can park or store several unmanned vehicles at the same time.

Preferably, the sky tree for unmanned aerial vehicles is in the overall shape of a pillar, and the parking rooms are provided on a side of the trunk.

Preferably, the lower portion of the sky tree for unmanned aerial vehicles is provided on a ground or fixed on a building, so as to facilitate mounting of the sky tree. One can base on the number of unmanned aerial vehicles in the urban region and the strength of the sky tree communication ability to layout the sky tree for unmanned aerial vehicles.

Preferably, the lower portion of the sky tree for unmanned aerial vehicles may be provided on a car or on a ship so as to form a movable car-mounted sky tree for unmanned aerial vehicles or ship-borne sky tree for unmanned aerial vehicles.

To facilitate the mounting of the sky tree for unmanned aerial vehicles on a car or on a ship, the trunk has an extendable multi-layer tubular structure that can reduce or extend the length of the trunk so as to change the size of the sky tree for unmanned aerial vehicles.

When the number of sky trees in a region is becoming larger, we call this cluster phenomenon a sky forest. The sky forest contains many different kinds of sky tree. Hence, there is a need to control different types of unmanned aerial vehicle flying and landing at any time in low altitude airspace.

In order to solve the problem of controlling the unmanned aerial vehicles and making an orderly operation, the present disclosure also provides a sky forest for unmanned aerial vehicles, which may include:

a plurality of the above-mentioned sky trees provided within a geographic region; and a control center for registering and controlling all of the sky trees for unmanned aerial vehicles, flight routes and timetables of the unmanned aerial vehicles within the geographic region.

Preferably, the control center is provided with public radio channels for identification and communication of different unmanned aerial vehicles approaching on their flight routes, and the control center sets priority of routes so that when the unmanned aerial vehicles belonging to the sky trees from different geographical regions are getting closer to each other, the unmanned aerial vehicles of higher priority advance, while the unmanned aerial vehicles of lower priority hover and wait.

Preferably, the control center adopts radio channel tiered control, i.e., control signals from the control center are transmitted to each sky tree for unmanned aerial vehicles, and each sky tree for unmanned aerial vehicles emits the control signals to unmanned aerial vehicles belonging thereto.

Preferably, the unmanned aerial vehicles are differentiated by colors and numbers. The unmanned aerial vehicles of sky trees belonging to different regions have different colors to differentiate their function and use, and different letters and numbers are used to distinguish each unmanned aerial vehicle.

The beneficial effects of the present disclosure are as follows:

1. The sky tree serves as an extension of the flight and communication of the unmanned aerial vehicles and power supply to allow round-the-clock usage. It becomes a public property and provides unmanned aerial vehicles in a region with logistic support which integrates dispatching command, application monitoring, communication relay, and replenishment.

2. The sky forest contains many different kinds of sky tree and different types of unmanned aerial vehicle, which solves the problem of orderly operation of take-off and landing of unmanned aerial vehicles at any time in low altitude airspace.

The present disclosure will be further explained in conjunction with the drawings and embodiments.

### BRIEF DESCRIPTION OF THE DRAWINGS

FIG. 1 is a schematic diagram of the sky tree for unmanned aerial vehicles of the first embodiment.

FIG. 2 is a schematic diagram of the flight route of the sky tree for unmanned aerial vehicles of the first embodiment.

FIG. 3 is a schematic diagram of the sky tree for unmanned aerial vehicles of the second embodiment.

FIG. 4 is a schematic diagram of the flight route of the sky tree for unmanned aerial vehicles of the second embodiment.

FIG. 5 is a schematic diagram of the sky tree for unmanned aerial vehicles of the third embodiment.

FIG. 6 is a schematic diagram of the flight route of the sky tree for unmanned aerial vehicles of the third embodiment.

FIG. 7 is a schematic diagram of the sky tree for unmanned aerial vehicles of the fourth embodiment.

FIG. 8 is a schematic diagram of the flight route of the sky tree for unmanned aerial vehicles of the fourth embodiment.

FIG. 9 is a schematic diagram of the status of the sky forest in a region of Shenzhen, China at 8:00 in the morning of the fifth embodiment.

FIG. 10 is a schematic diagram of the status of the sky forest in a region of Shenzhen, China at 14:00 in the afternoon of the fifth embodiment.

FIG. 11 is a schematic diagram of the status of the sky forest in a region of Shenzhen, China at 18:00 at dusk of the fifth embodiment.

In the figures: 1—sky tree, 2—control center, 3—communication base station, 4—specific channel antennas, 11—trunk, 12—flight platform, 13—elevator, 14—parking room, 15—command center, 16—supply station.

### DETAILED DESCRIPTION

The following embodiments are the preferred modes of embodying of the present disclosure, and any other embodiments where their principle and basic structure are identical or similar to these embodiments are also within the scope of protection of the present disclosure.

The present disclosure can be further understood by the embodiments of the present disclosure provided below. However, these embodiments are not a limitation to the present disclosure. Those features of the specific embodiments that are not described in detail can be obtained by using existing technology, public knowledge and industry standards.

### Embodiment 1—Sky Tree for Unmanned Aerial Vehicles for Light Freight

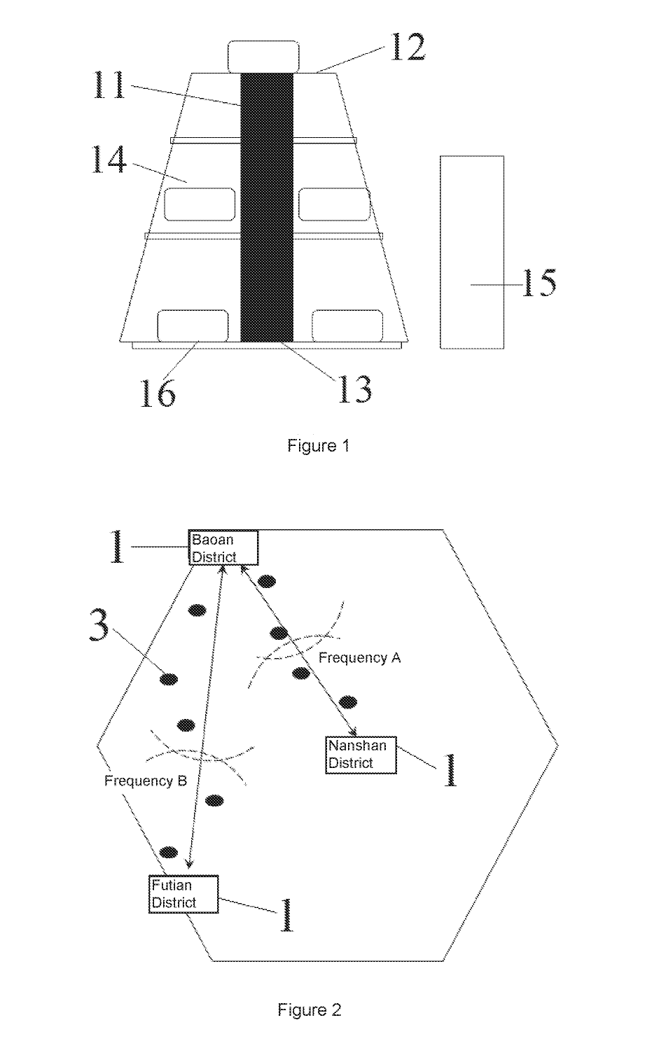

Referring to FIGS. 1 and 2, a tower-shaped sky tree 1 can be set up on the top floor of a science and technology building in Nanshan District, Shenzhen, China. The overall sky tree may be in the shape of a tower. The sky tree may include:

a trunk 11 which may have a height of 3 meters and may extend from the top of the building to a high altitude, an inner portion of the trunk 11 may be having a hollow structure;

a flight platform 12 which may be provided at a top end of the trunk 11 for take-off and landing of unmanned aerial vehicles, and may hold an unmanned aerial vehicle;

an elevator 13 which may be provided inside the trunk 11 for carrying unmanned aerial vehicles up or down between the lower portion and the flight platform 12, and can move any unmanned aerial vehicle to the flight platform at any time;

a parking room 14 which may be provided on the trunk 11, and may form a multilayer branching structure for the parking of several unmanned aerial vehicles;

a command center 15 which may act as a radio relay station to dispatch and control the flights of the unmanned aerial vehicles using radio communication; and

a supply station 16 which may be used to recharge or refuel the unmanned aerial vehicles so as to increase the flight time of the unmanned aerial vehicles.

The sky tree can be used for express delivery of freight. Unmanned aerial vehicles can collect light, high urgency goods in Nanshan district, and directly fly to Baoan district. Hourly departure flights can be scheduled. The flight distance may be within 20 kilometers, and the flight time may be within 30 minutes.

The sky tree can be used to communicate in the following ways to control the flight route of the light freight unmanned aerial vehicles:

1. When a mobile phone number is provided, use the mobile communication base station 3 along the flight to communicate via 2G/3G/4G so that the signal is not easily interfered. One can refer to Chinese Patent Application Publication No. CN102637023A which discloses a remote unmanned aerial vehicles cluster control method based on 3G (3rd Generation), GPRS (General Packet Radio Service) mobile communication. In a city, this kind of mobile phone communication method is the main communication method.

2. When GPS (Global Positioning System) is provided, flight is carried out according to the latitude and longitude coordinates on a map. One can refer to Chinese Patent Application Publication No. CN102637023A which discloses a remote unmanned aerial vehicles cluster control method based on 3G, GPRS mobile communication, and Chinese Patent Application Publication No. CN103532613A which discloses an unmanned aerial vehicle remote task uploading system and method based on Beidou communication.

3. The unmanned aerial vehicles can also fly within a two-point intersection range according to a specific channel, e.g. 1 of the 2.4G/channel.

The tower-shaped sky tree itself, formed by a trunk and branches, is a large radio antenna, which can act as a communication relay system for the unmanned aerial vehicles, and can facilitate communication of the unmanned aerial vehicles. In addition, the parking room can park or store many unmanned aerial vehicles at the same time.

### Embodiment 2—Sky Tree for Unmanned Aerial Vehicles for Border Security

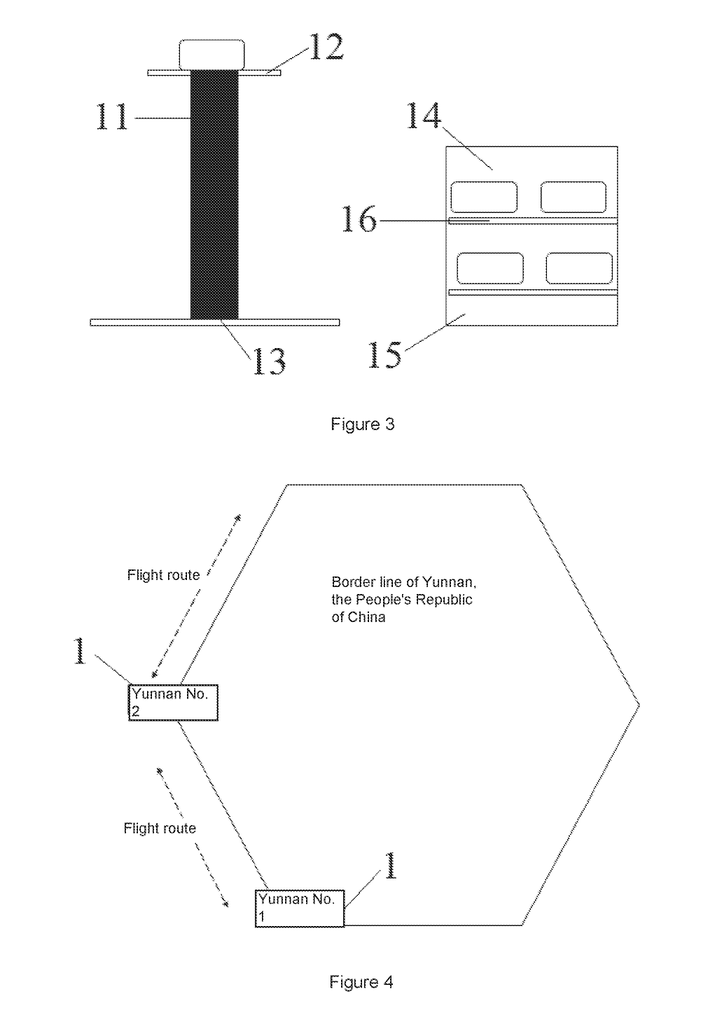

Referring to FIGS. 3 and 4, a pillar-shaped sky tree 1 can be set up at the border between Yunnan, China and Burma. The overall pillar-shaped sky tree may include:

a trunk 11 which may have a height of 5 meters and may extend from the ground to a high altitude, an inner portion of the trunk 11 may be having a hollow structure;

a flight platform 12 which may be provided at a top end of the trunk 11 for take-off and landing of unmanned aerial vehicles, and may hold an unmanned aerial vehicle;

an elevator 13 which may be provided inside the trunk 11 for carrying unmanned aerial vehicles up or down between the ground and the flight platform 12, and can move any unmanned aerial vehicle to the flight platform at any time;

a parking room 14 for the parking of several unmanned aerial vehicles;

a command center 15 which may act as a radio relay station to dispatch and control the flights of the unmanned aerial vehicles using radio communication; and

a supply station 16 which may be used to recharge or refuel the unmanned aerial vehicles so as to increase the flight time of the unmanned aerial vehicles.

The sky tree can be used for border security inspection. Hourly departure flights can be scheduled. The flight distance may be within 20 kilometers, and the flight time may be within 30 minutes. It can carry high-resolution photo/video taking equipment to monitor illegal entry and smuggling.

The sky tree can be used to communicate in the following ways to control the flight routes of the border security unmanned aerial vehicles:

1. When GPS (Global Positioning System) is provided, flight is carried out according to the latitude and longitude coordinates on a map. One can refer to Chinese Patent Application Publication No. CN102637023A which discloses a remote unmanned aerial vehicles cluster control method based on 3G, GPRS mobile communication, and Chinese Patent Application Publication No. CN103532613A which discloses an unmanned aerial vehicle remote task uploading system and method based on Beidou communication.

2. The unmanned aerial vehicles can also fly within a two-point intersection range according to a specific channel having a long wavelength, e.g. 450 MHz/channel, as this channel can transmit long distance according to the specific channel.

3. When a mobile phone number is provided, use the mobile communication base station 3 along the flight to communicate via 2G/3G/4G so that the signal is not easily interfered. In view of the remoteness of the border and the number of mobile communication base stations is small, this is a secondary communication method.

### Embodiment 3—Sky Tree for Unmanned Aerial Vehicles for Public Power

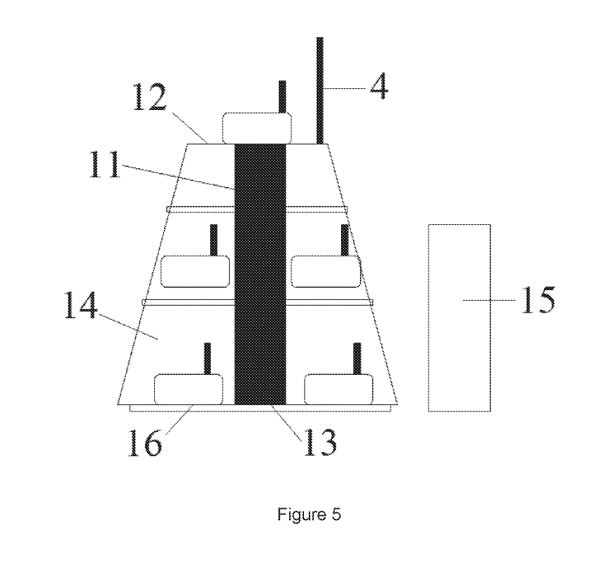

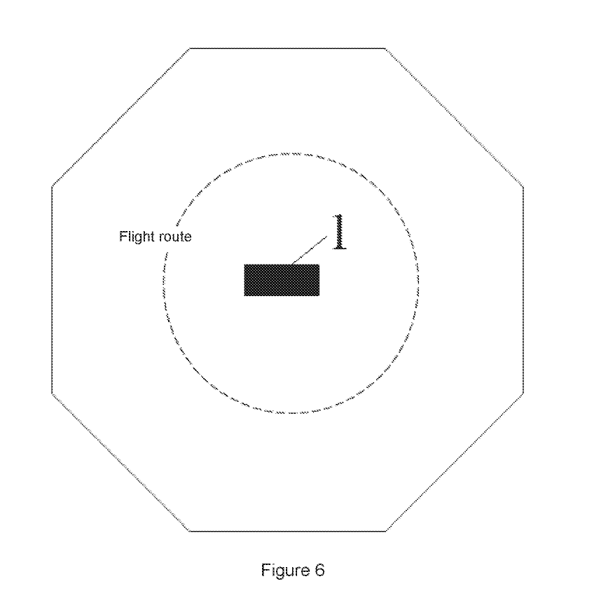

Referring to FIGS. 5 and 6, tower-shaped sky tree 1 can be set up at the heart of the capital of Beijing, China. The overall tower-shaped sky tree may include:

a trunk 11 which may have a height of 5 meters and may extend from the ground to a high altitude, an inner portion of the trunk 11 may be having a hollow structure;

a flight platform 12 which may be provided at a top end of the trunk 11 for take-off and landing of unmanned aerial vehicles, and may hold an unmanned aerial vehicle;

an elevator 13 which may be provided inside the trunk 11 for carrying unmanned aerial vehicles up or down between the ground and the flight platform 12, and can move any unmanned aerial vehicle to the flight platform at any time;

a parking room 14 for the parking of several unmanned aerial vehicles;

a command center 15 which may act as a radio relay station to dispatch and control the flights of the unmanned aerial vehicles using radio communication; and

a supply station 16 which may be used to recharge or refuel the unmanned aerial vehicles so as to increase the flight time of the unmanned aerial vehicles.

A specific channel antenna 4 may be set on the flight platform for the receiving and feedback of radio signals for a particular channel.

The function of the public power sky tree is to dispatch unmanned aerial vehicles with extra large radio power in order to suppress and disturb other illegal unmanned aerial vehicle remote system and prevent them from entering the capital center for illegal reconnaissance.

The public power sky tree can control the flight routes of unmanned aerial vehicles according to specific channel communication, e.g. a licensed channel to prevent any interference.

### Embodiment 4—Ship-Borne Sky Tree for Unmanned Aerial Vehicles

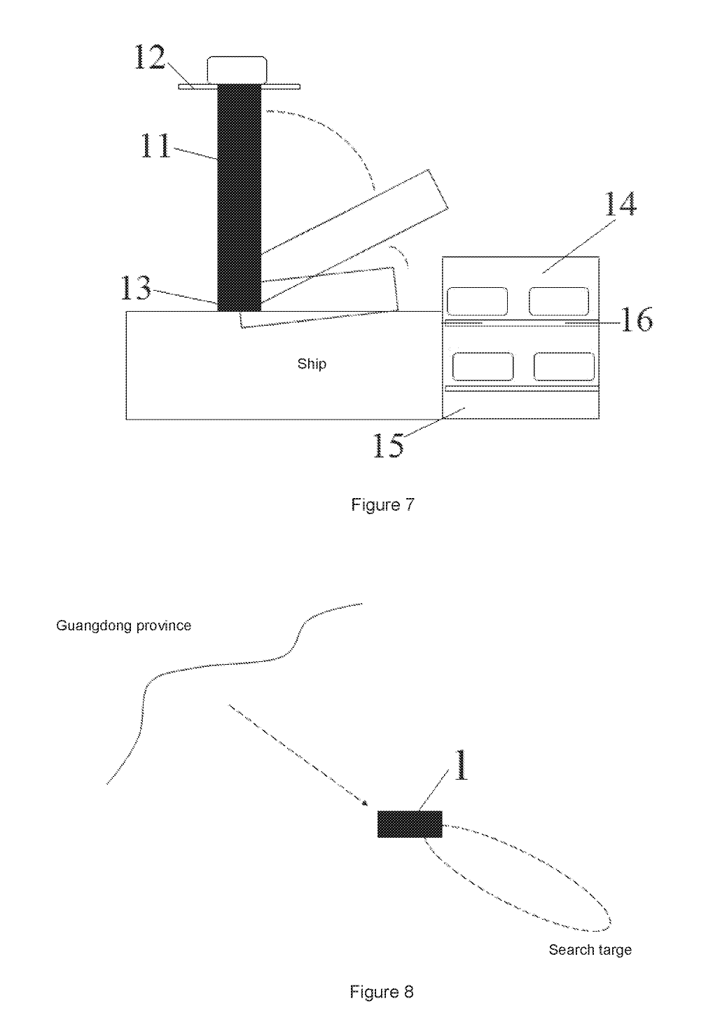

Referring to FIGS. 7 and 8, a pillar-shaped ship-borne sky tree can be set up in the South China Sea region of the Guangdong province. After sailing to a fixed point, a ship-borne sky tree for unmanned aerial vehicles 1 can be set up based on investigation requirement and lifting height. The overall pillar-shaped sky tree may include:

a trunk 11 which may have a height of 5 meters and may extend from the ship to a high altitude, an inner portion of the trunk 11 may be having a hollow structure;

a flight platform 12 which may be provided at a top end of the trunk 11 for take-off and landing of unmanned aerial vehicles, and may hold an unmanned aerial vehicle;

an elevator 13 which may be provided inside the trunk 11 for carrying unmanned aerial vehicles up or down between the lower portion and the flight platform 12, and can move any unmanned aerial vehicle to the flight platform at any time;

a parking room 14 for the parking of several unmanned aerial vehicles;

a command center 15 which may act as a radio relay station to dispatch and control the flights of the unmanned aerial vehicles using radio communication; and

a supply station 16 which may be used to recharge or refuel the unmanned aerial vehicles so as to increase the flight time of the unmanned aerial vehicles.

The trunk 11 may have an extendable multi-layer tubular structure which can reduce or extend the length of the trunk so as to change the size of the sky tree for unmanned aerial vehicles. This can facilitate the placing of sky tree on a ship or on a car.

The sky tree can be used as a long-range, low altitude sea reconnaissance, and marine scientific research. The unmanned aerial vehicles may carry equipment for high-resolution photo/video taking.

The sky tree can control the flight routes of unmanned aerial vehicles according to specific channel communication, e.g. a licensed channel to prevent any interference.

### Embodiment 5—Sky Forest for Unmanned Aerial Vehicles in Shenzhen Area

In 2025, the Shenzhen area has set up 150 sky trees 1 and formed a sky forest. This sky forest may have a control center 2 that may control five types of sky tree. These five types of sky tree may be: 1 light freight, 2 security monitoring, 3 disaster relief, 4 news, 5 public power. They may be painted in different colors, such as 1 green, 2 white, 3 yellow, 4 blue, 5 red. Each unmanned aerial vehicle in Shenzhen district may be assigned a number with SH as a prefix.

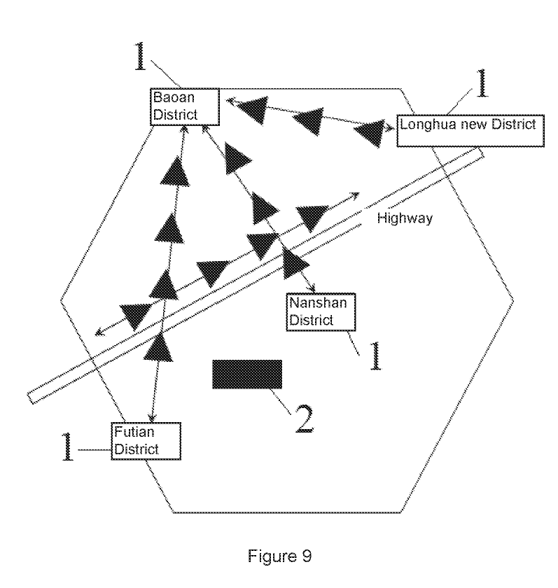

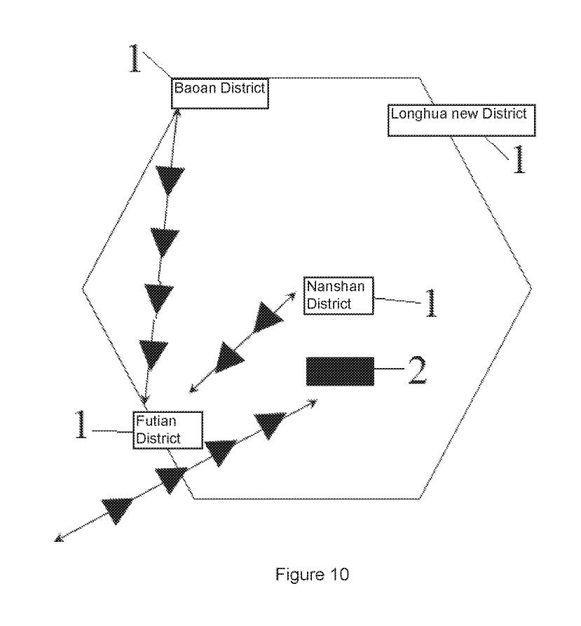

At 8:00 in the morning on the 10^{th} of March 2025, Shenzhen is busy in the sky. Referring to FIG. 9, green unmanned aerial vehicles from Nanshan district, Futian district and Longhua new district begin to fly to Baoan district for freight delivery, while the blue unmanned aerial vehicles also begin to fly over a highway to obverse and report road condition.

At 14:00 in the afternoon, a fire breaks out in a residence home in Futian district, Shenzhen. Referring to FIG. 10, yellow disaster relief unmanned aerial vehicles of Nanshan district and Futian district begin to be dispatched to the scene for inspection, and blue unmanned aerial vehicles begin to fly to Futian district for news coverage.

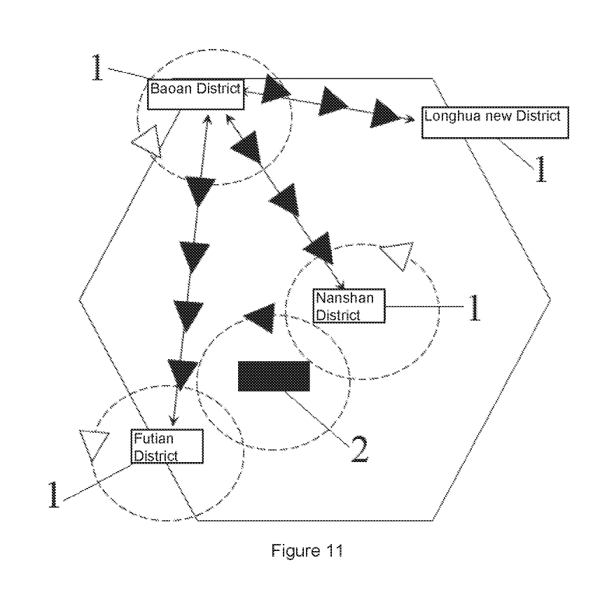

At 18:00 in the evening, the situation of the sky forest in Shenzhen district. Referring to FIG. 11, the green unmanned aerial vehicles from Baoan district begin to return to Nanshan district, Futian district and Longhua new district for freight delivery. The sky forest control center sends out public power unmanned aerial vehicles to carry out routine flights. White surveillance unmanned aerial vehicles from various districts of the Shenzhen city also begin to cruise the security situation in various districts.

In order to solve the problem of unmanned aerial vehicle management in Shenzhen area and make it operates in an orderly manner, the control center of the sky forest for unmanned aerial vehicles in Shenzhen area may have public radio channels for identification and communication of different unmanned aerial vehicles approaching on their flight routes, and the control center sets priority of routes so that when the unmanned aerial vehicles belonging to the sky trees from different geographical regions are getting closer to each other, the unmanned aerial vehicles of higher priority advance, while the unmanned aerial vehicles of lower priority hover and wait.

The control center may also use radio channel tiered control, i.e., control signals from the control center are transmitted to each sky tree for unmanned aerial vehicles, and each sky tree for unmanned aerial vehicles emits the control signals to unmanned aerial vehicles belonging thereto.

The above disclosed is only the preferred embodiments of the present disclosure. Of course, it cannot be used to limit the scope of protection of the present disclosure. Therefore, any equivalent modifications made according to the scope of the claims are still within the scope covered by the present disclosure.

What is claimed is:

1. A sky tree for unmanned aerial vehicles, comprising:
a trunk extending from a lower portion to a high altitude, an inner portion of the trunk having a hollow structure;
a flight platform located at a top end of the trunk for take-off and landing of the unmanned aerial vehicles;
an elevator provided inside the trunk for carrying the unmanned aerial vehicles up or down between the lower portion and the flight platform;
parking rooms for parking of the unmanned aerial vehicles; and
a command center to control flights of the unmanned aerial vehicles using radio communication.

2. The sky tree for unmanned aerial vehicles according to claim 1, further comprising a supply station to recharge or refuel the unmanned aerial vehicles.

3. The sky tree for unmanned aerial vehicles according to claim 1, wherein the command center uses 2G, 3G or 4G mobile communication, global positioning system (GPS) communication, or specific channel radio communication.

4. The sky tree for unmanned aerial vehicles according to claim 1, wherein the sky tree for unmanned aerial vehicles is in an overall shape of a tower, and the parking rooms are provided on the trunk to form a multi-layer branching structure.

5. The sky tree for unmanned aerial vehicles according to claim 1, wherein the sky tree for unmanned aerial vehicles is in an overall shape of a pillar, and the parking rooms are provided on a side of the trunk.

6. The sky tree for unmanned aerial vehicles according to claim 1, wherein the lower portion of the sky tree for unmanned aerial vehicles is provided on a ground, or fixed on a building, or provided on a car or a ship.

7. The sky tree for unmanned aerial vehicles according to claim 6, wherein the trunk has an extendable multi-layer tubular structure.

8. A sky forest for unmanned aerial vehicles, comprising a plurality of sky trees each being the sky tree as claimed in claim 1 provided within a geographic region; and a control center for registering and controlling all of the sky trees, flight routes and timetables of the unmanned aerial vehicles within the geographic region.

9. The sky forest for unmanned aerial vehicles according to claim 8, wherein the control center is provided with public radio channels for identification and communication of different unmanned aerial vehicles approaching on the flight routes thereof, and the control center sets priority of routes so that when the unmanned aerial vehicles belonging to the sky trees from different geographical regions are getting closer to each other, the unmanned aerial vehicles of higher priority advance, while the unmanned aerial vehicles of lower priority hover and wait.

10. The sky forest for unmanned aerial vehicles according to claim 8, wherein control signals from the control center are transmitted to each sky tree, and each sky tree emits the control signals to the unmanned aerial vehicles belonging thereto.
